(19) United States
(12) Patent Application Publication
(10) Pub. No.: US 2010/0090943 A1
(43) Pub. Date: Apr. 15, 2010

(54) Electrophoretic Display Apparatus and Method

(76) Inventors: Peter J. Fricke, Corvallis, OR (US); Laura L. Kramer, Corvallis, OR (US); Gregg A. Combs, Monmouth, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/251,009

(22) Filed: Oct. 14, 2008

(51) Int. Cl. G09G 3/34

(52) U.S. Cl. 345/107

(57) ABSTRACT

An electrophoretic display apparatus includes an array of cells each comprising first and second electrodes and a plurality of electrophoretic particles disposed between the electrodes, wherein the particles are dispersed in a host fluid and are multistable in positions between the electrodes; and drive circuitry in electrical communication with each of the electrodes. The drive electronics are configured to transition addressed cells of the array from a first optical state to a second optical state with a plurality of successive write signals.

### BACKGROUND

An electrophoretic display device requires very little power to display images. Electrical writing signals are initially applied to the display device to cause each pixel to appear, for example, light or dark, in accordance with the image to be displayed. After the pixels of the display have collectively achieved the desired appearance, no further power is required to maintain the display of the resulting image. Rather, the image remains stable until electrical signal are again applied to alter the appearance of the pixels.

Each pixel corresponds to a cell in the electrophoretic display. In each cell, a quantity of tiny particles is dispersed in a host fluid. In some cases, the liquid host fluid is a liquid crystal (LC) material. The particles are electrically charged and can be manipulated to migrate through the host fluid in response to an applied electric field.

This migration of the charged particles will change the optical state or appearance of that cell. For example, causing the cell to appear light or dark. There are different mechanisms that allow the cells to change appearance in response to migration of the charged particles.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIGS. 1A and 1B are cross-sectional views of an illustrative embodiment of an electrophoretically controlled liquid crystal display cell, according to principles described herein.

FIGS. 2A and 2B are cross-sectional views of illustrative embodiments of an electrophoretically controlled liquid crystal display cell, according to principles described herein.

FIGS. 3A and 3B is an illustration of an illustrative embodiment of charged particles dispersed within an illustrative liquid crystal host fluid, according to principles described herein.

FIG. 4 is an illustration of an illustrative embodiment of an electrophoretically controlled liquid crystal display device, according to principles described herein.

FIG. 5 is an illustration of an illustrative embodiment of a control system in an electrophoretically controlled liquid crystal display device, according to principles described herein.

FIG. 6 is an illustrative table of control line voltages in an electrophoretically controlled liquid crystal display device according to principles described herein.

FIG. 7 is a representation of illustrative net voltages imposed on individual cells during a write process of an illustrative electrophoretically controlled liquid crystal display device according to principles described herein.

FIG. 8 is a diagram depicting illustrative voltages present in an illustrative electrophoretically controlled liquid crystal display cell during different operations of a display device according to principles described herein.

FIG. 9A-9E are cross-sectional views of an illustrative electrophoretically controlled liquid crystal display cell during throughout multiple write operations, according to principles described herein.

FIG. 10 is a flowchart of an illustrative method of electrophoretically displaying an image, according to principles described herein.

Throughout the drawings, identical reference numbers designate similar, but not necessarily identical, elements.

### DETAILED DESCRIPTION

The present specification discloses apparatus for, and methods of operating, a passively addressed electrophoretic display. The apparatus and methods described utilize multiple low-voltage write passes to reduce crosstalk between display cells and improve contrast in the images displayed.

In general, there are two basic architectures for a cell of an electrophoretic display utilizing a liquid crystal host fluid: (1) Electrophoretic Liquid Crystal (EPLC) type displays and (2) Electrophoretically Controlled Nematic (EPCN) type displays. The principles of the present specification can be applied to either type of electrophoretic display. Both types of displays will be described briefly.

In an Electrophoretic Liquid Crystal (EPLC) type display, each cell includes two opposed electrodes. Depending on the electrical field created between the electrodes, the charged particles migrate toward one or the other of the electrodes. This movement of the charged particles brings the particles in or out of view. When the particles are located in view, the cell takes on a color determined by the particles. In some electrophoretic devices, the host fluid has a contrasting color with the color of the particles. Thus, when the particles are out of view, the cell takes on the color of the host fluid. Some such electrophoretic display devices utilize two groups of charged particles, each group having a different color and opposite electrical charge.

EPLC type displays can be configured with the opposing electrodes being arranged vertically with one being an upper electrode and one being a lower electrode with respect to the display surface of the display device. EPLC type displays can also be configured with the electrodes being in-plane, i.e., in a common plane. In such examples, the charged particles moving laterally between the electrodes in response to an applied electric field.

In an Electrophoretically Controlled Nematic (EPCN) type display, nanoparticles that are added to a liquid crystal host material affect the alignment of the liquid crystal molecules. The alignment of the liquid crystal molecules can be either parallel or normal to the electrical field between the electrodes. As the nanoparticles are electrophoretically moved between the electrodes, they form a network that stabilizes the liquid crystal molecule alignment in the orientation caused by the applied field.

The electrodes are coated with alignment layers to impart a preferred liquid crystal molecule orientation at each interface. For example, one electrode may impart homeotropic alignment and the other may impart planar alignment. In a positive liquid crystal in which the long axis of molecules aligns parallel to the applied field, when the nanoparticles are located near the homeotropic alignment layer, the liquid crystal molecules adopt a hybrid aligned nematic (HAN) configuration between that first electrode and a second electrode. However, as the charged nanoparticles are electrophoretically moved from the first electrode to the second electrode with planar alignment, the planar alignment is suppressed and the liquid crystal molecules are vertically aligned between the two electrodes.

With a polarizer or dichroic colorant, the cell will have a different optical appearance depending on whether the liquid crystal molecules between the electrodes are in the HAN or vertical configuration. And, the alignment configuration of the liquid crystal molecules will depend on whether the nanoparticles are located at a first electrode or have migrated to a second electrode, changing the alignment status of the liquid crystal molecules. In this example, when the nanoparticles return to the first electrode the liquid crystal molecules between the two electrodes are again in the HAN configuration.

As used in the present specification and in the appended claims the term “bistable” or “bistability” refers to the property of a cell of an electrophoretic display to be stable in either a first or second optical state, e.g., having a light or a dark color. The cell will remain in its current optical state stably until an electric field is again applied to cause migration of the charged particles.

As used in the present specification and in the appended claims, the term “multi-stable” or “multi-stability” refers to the property of a cell of an electrophoretic display to be stable in any of many optical states. With multi-stability, the charged particles will remain wherever they are, even somewhere in between the two electrodes, in the absence of an electric field between the electrodes causing further migration.

Consequently, in an EPLC pixel, the cell may retain a state in which some of the charged particles are in view and some are not, giving the cell a color somewhere between that when all or none of the particles are in view. Similarly, in an EPCN pixel, the layer of particles may be stopped somewhere in between the two electrodes with some of the liquid crystal molecules aligned on one side of the layer of particles and the liquid crystal molecules unaligned on the other side of the layer of particles. As in the previous example, this will give the cell and optical state or appearance that is in between the extremes of having the liquid crystal molecules either aligned or unaligned.

Thus, multi-stability allows the cells or pixels of the electrophoretic display to take on any of a number of intermediate shades or colors thus allowing the image to be displayed in grayscale. The principles of described in the present specification can be applied to both bistable and multi-stable display devices.

As used in the present specification and in the appended claims, the term “active addressing” refers to a control scheme in a display device in which each cell in the display is addressed individually through an active device such as a thin film transistor.

As used in the present specification and in the appended claims, the term “passive addressing” refers to a control scheme in a display device in which the rows and columns of the display are addressed in parallel. Selected pixels require a voltage threshold to change state.

In a simple passively addressed display device, an image is written to the device in a single pass. During this single pass, selected cells experience a high voltage once for a particular amount of time, while non-selected pixels experience a fraction of that voltage (typically between a half and a third of the high voltage) many times. Some electrophoretic devices exhibit crosstalk between display cells when written in this fashion. This is caused by the absence of a voltage threshold, or a voltage threshold that is too low. However, in some cases lower write voltages used in a single pass passively addressed device do not produce a sufficient optical contrast between written cells and unaddressed cells.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to illustrative systems and methods.

### Illustrative Systems

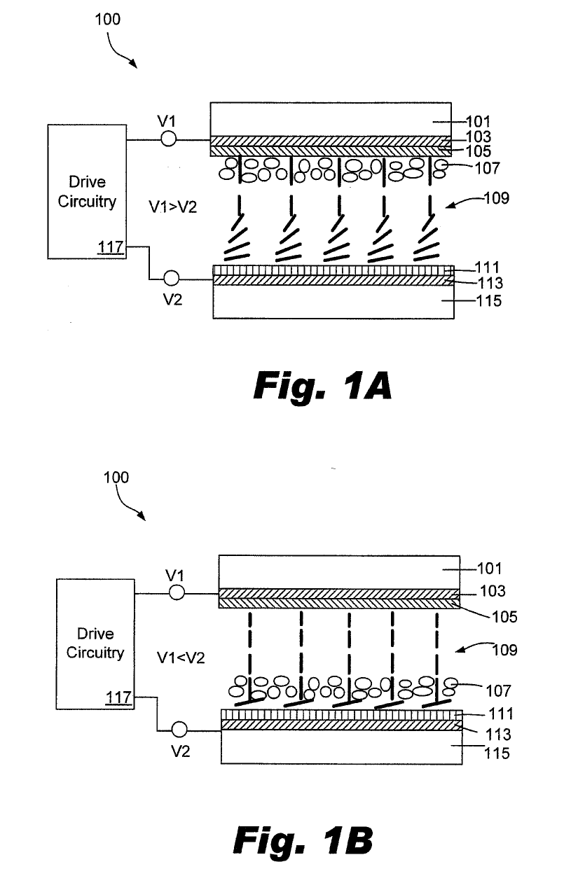

Referring now to FIGS. 1A and 1B, a cross-sectional view of an illustrative display cell (100) of the EPCN type is shown. The illustrative display cell (100) may be used as a single picture element (pixel) in an electrophoretic display device. The display cell (100) has first and second opposed substrates (101, 115) that support opposing cell electrodes. The substrates (101, 115) may be made from any of a variety of materials including glass, plastics, such as polyethersulfone (PES), and other materials. Each of the substrates (101, 115) has one of the first and second electrodes (103, 113, respectively) disposed thereon.

The electrodes (103, 113) are configured to receive an electrical potential or voltage from nodes (V1, V2) and impart an electrical field between the opposing electrodes (103, 113), according to the applied voltage. A liquid crystal host fluid (109) is disposed between the first and second substrates (101, 115) and their associated layers. Charged electrophoretic particles (107) are dispersed within the liquid crystal host fluid (109). Moreover, at least one of the first and second substrates (101, 115) and their associated layers is transparent such that the optical properties of the display cell (100) are determined by relative orientation of the liquid crystal host fluid (109) and the electrophoretic particles (107).

Additionally, first and second alignment layers (105, 111) may be disposed on the first and second electrodes (103, 113), respectively. In the present example, a first alignment layer (105) located with the upper electrode (103) is a homeotropic alignment layer that provides vertical alignment of liquid crystal molecules close to the surface of the first alignment layer (105). The first alignment layer may include a chrome complex or other homeotropic alignment material known in the art.

A second alignment layer (111) located with the lower electrode (113) in the present example is a planar alignment layer including a rubbed polymide material or other planar alignment material known in the art. The second alignment layer (111) is configured to provide horizontal alignment of the liquid crystal molecules close to the surface of the layer (111).

The orientation of molecules in the liquid crystal host fluid and the electrophoretic particles (107) in between the first and second alignment layers (105, 111) may be affected by the polarity and magnitude of voltages applied at the first and second electrodes (103, 113) from the nodes (V1, V2). The electrophoretic particles (107) may be electrophoretically moved from one side of the cell (100) to another, changing the liquid crystal alignment at the interface of the substrate layers (103, 105) and the liquid crystal host fluid (109). Furthermore, when an electric field is applied between the first and second electrodes (103, 113), the molecules of the liquid crystal host fluid (109) tend to become aligned with the electric field, with the exception of the liquid crystal molecules closest to the planar alignment layer (111) of the second substrate (115).

The illustrative display cell (100) is shown in FIG. 1A with a voltage at V1 that is greater than the voltage at V2. The electrophoretic particles (107) of the present example are negatively charged, and are thus attracted to the first electrode (103) on substrate (101). In embodiments where the side of the display cell (100) having the first substrate (101) is transparent and presented to a viewer as a display device surface, the display cell (100) takes on an appearance dependant on the orientation of the liquid crystal molecules under the conditions shown in FIG. 1A. The liquid crystal molecule orientation can be viewed using crossed polarizers or a dichroic dye.

The illustrative display cell (100) is shown in FIG. 1 B with a voltage at V2 that is greater than the voltage at V1. The electrophoretic particles (107) are thus attracted to the second electrode (113) on the substrate (115). In embodiments where the side of the display cell (100) having the first substrate (101) is presented to the viewer as the display surface, the display cell (100) takes on an appearance dependant on the orientation of the liquid crystal molecules made visible using crossed polarizers or a dichroic dye.

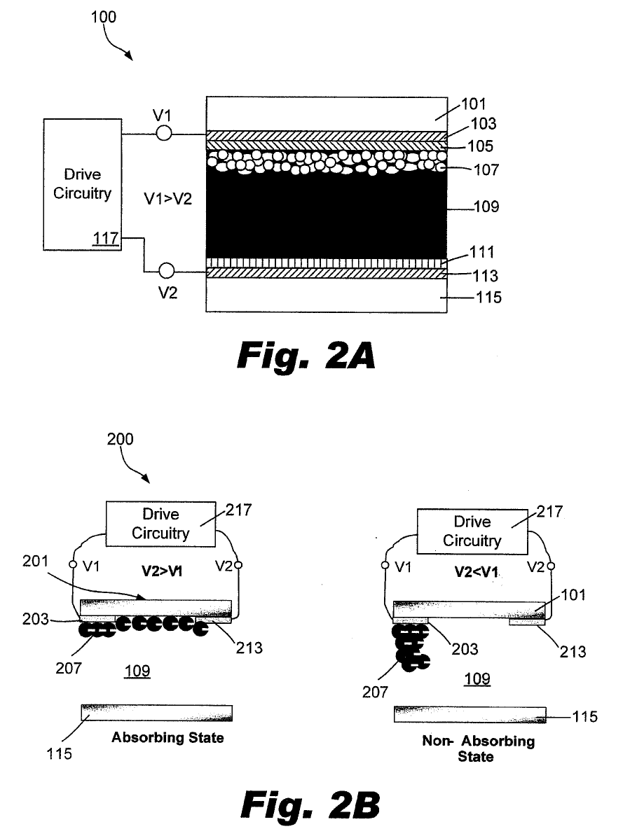

In some embodiments, the display cell (100) may include electrophoretic particles (107) having positive and negative charges. This pixel architecture results in slightly different liquid crystal alignment states than the single particle scenario. In addition the EPCN system can be operated using in-plane electrodes, as described below in connection with FIG. 2b.

Drive circuitry (117) is electrically connected to the display cell (100) and configured to control the voltage levels at each of the nodes, V1 and V2, according to the characteristics of the specific system. The drive circuitry (117) is configured to transition the display cell (100) from a first optical state to a second optical state over a plurality of successive passes, as is discussed in more detail below.

Referring now to FIG. 2A, an illustrative display cell (100) of the EPLC type is shown. The upper substrate (101) is the display surface in this example. The electrophoretic particles (107) have a color, such as white, that contrasts with a color of the colorant in the liquid crystal host fluid (109). Thus, when a voltage is applied across the nodes (V1, V2) that attracts the electrophoretic particles (107) to the first electrode (103), the display cell (100) may take on the visual color of the electrophoretic particles (107). When a voltage is applied across the nodes (V1, V2) that attracts the electrophoretic particles (107) to the second electrode (113), the display cell (100) may take on the visual color of the colorant in the liquid crystal host fluid (109). Thus, two discrete optical states are available in the display cell (100).

FIG. 2B illustrates two different states of an illustrative display cell (200) of the EPLC type with an in-plane electrode configuration. As shown in FIG. 2B, a host fluid (109) is provided between opposing substrates (101, 115). However, the electrodes (203, 213) need not be on different substrates, but can, as shown in FIG. 2B, be located on the same substrate (101).

In some EPLC embodiments, the display cell (100) may include electrophoretic particles (107) having positive and negative charges, wherein all of the positively charged electrophoretic particles have one color or appearance and all of the negatively charged electrophoretic particles have another color or appearance, distinguishable from the first color or appearance. In these embodiments, the display cell (100) will take on the color and appearance of the negatively charged electrophoretic particles (107) when V1>V2, and will take one the color and appearance of the positively charged electrophoretic particles when V2>V1.

As before, drive circuitry (217) supplies a voltage difference to the electrodes (203, 213) to create an electric field. The charged particles (207) migrate in response to this field.

On the left of FIG. 2B, the voltage V2 on the right electrode (213) is greater than the voltage V1 at the left electrode (203). As shown in the figure, this causes the charged particles (207) to migrate into the area between the electrodes (203, 213) where they are visible through a pixel window (201) and define the color of the cell (200). This may also be referred to as an absorbing state because the charged particles (207) absorb particular light wavelengths and reflect/transmit only the complementary wavelengths (i.e., color).

On the right of FIG. 2B, the opposite “non-absorbing state” is illustrated. In this example, the voltage V2 on the right electrode (213) is now less than the voltage V1 at the left electrode (203). As shown in the figure, this causes the charged particles (207) to migrate into the area below the left electrode (203) and out of view through the pixel window (201). In this state, the cell (200) is generally reflective/transmissive and appears light.

In an electrophoretic cell with in-plane electrodes, the liquid crystal alignment layers described above may be used, but can also be omitted. Additionally, the host fluid (109) need not include a dye. The charged particles (207) may be charged pigments that are completely hidden to the viewer in the non-absorbing state and partially or fully viewable in the absorbing state. While the typical in-plane configuration includes the opposing electrodes on a single substrate as shown in FIG. 2B. However, the opposing electrodes do not have to be on the same substrate. The electrodes can be place on opposite sides of the pixel window (201), but with one on the upper substrate (101) and the other on the lower substrate (115).

When a new image is to be written to this type of electrophoretic display, all pixels are reset to the non-absorbing state. Then, for a given pixel that is to assume the absorbing state or a semi-absorbing state, an electric field is applied between the electrodes for a certain duration to cause the charged particles or pigments to migrate across the pixel window.

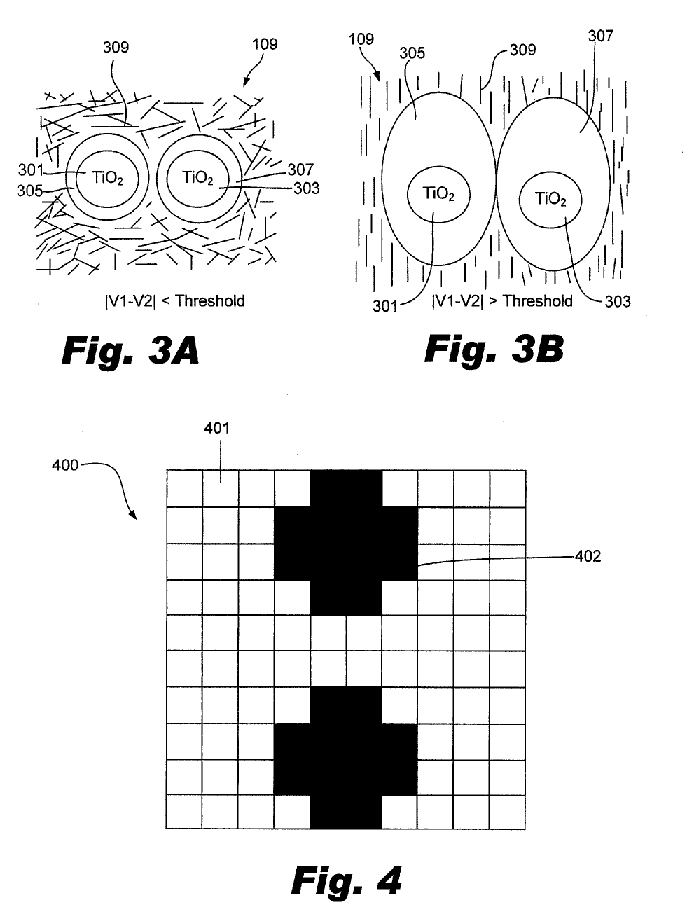

As indicated above, the various types of electrophoretic cells described herein exhibit multistability which enables the display of grayscale images. The multistability of an EPLC type electrophoretic cell will now be explained. Referring now to FIGS. 3A and 3B, a detailed view of illustrative electrophoretic particles (301, 303) dispersed in the liquid crystal host fluid (109) in an EPLC type cell is shown.

The liquid crystal host fluid (109) has a voltage threshold, which enables passive addressing in the display cells (100). The electrophoretic particles (301, 303) of the present example are titanium dioxide particles having a net negative charge. Titanium dioxide particles have a white appearance and are commonly used in electrophoretic displays. However, it should be understood that any of many available materials may be used for the electrophoretic particles (301, 303).

The electrophoretic particles (301, 303) typically already have a charge when introduced to the host fluid (109). However, in some embodiments, the particles (301, 303) may obtain their net charge by substances added to the liquid crystal host fluid (109) that react with the electrophoretic particles (301, 303) to create a net charge. These substances may include, but are not limited to, surfactants, dispersants and combinations thereof. Furthermore, electrophoretic particles (301, 303) in some embodiments may be treated to cause a net charge on the electrophoretic particles (301, 303) prior to dispersion in the liquid crystal host fluid (109).

As shown in FIG. 3A, when the net voltage between the electrodes (103, 113, FIG. 1) is below the threshold voltage needed to align the molecules of the liquid crystal host fluid (109), individual liquid crystal molecules (309) are oriented so as not to permit movement by the electrophoretic particles (301, 303) toward either of the electrodes (103, 113, FIG. 1). Therefore, when a net voltage below the threshold (including no net voltage at all) is applied between the electrodes (103, 113, FIG. 1), the display cell (100, FIG. 1) maintains its optical state, regardless of the relative position of the electrophoretic particles (301, 303). Thus, the system is multistable and allows for passive addressing as described herein.

As shown in FIG. 3B, movement towards one of the electrodes (103, 113, FIG. 1) by the electrophoretic particles (301, 303) is possible when the liquid crystal molecules (309) in the liquid crystal host fluid (109) are aligned in a certain orientation relative to the parallel electrodes (103, 113). This alignment in the liquid crystal molecules (309) occurs when the net voltage between the electrodes (103, 113) is greater than or equal to the threshold voltage. Again, the multistability enabled by the stability of the system combined with a voltage threshold allows passive addressing to be used with a matrix of display cells, as will be described in relation to other figures.

In FIGS. 3A and 3B, the electrophoretic particles (301, 303) are shown having an electrical double layer (307, 305, respectively). The electrical double layers (307, 305) are layers on the electrophoretic particles (301, 303) having an equal opposite charge from the electrophoretic particles (301, 303) themselves, so in a rest or neutral state the resultant charge of the electrophoretic particles is zero. Under the influence of the electrical field caused by the voltage between electrodes (103, 113), the double layers (307, 305) and the underlying charged particle will react to result in polarization of the electrophoretic particles (301, 303). This polarization is shown in FIG. 3B and causes the electrophoretic particles (301, 303) to then have a net charge such that the particle will move through the liquid crystal host fluid (109) under the influence of the electrical field. More details referring to bistable and multistable electrophoretic display devices may be found in U.S. Pat. No. 7,264,851 to David Sikharulidze, the entire contents of which is herein incorporated by reference.

Referring now to FIG. 4, an illustrative display device (400) is shown that includes a 10×10 array of electrophoretic display cells (401, 402). The transparent first substrate (101, FIG. 1) and its corresponding transparent layers (103, 105, FIG. 1) of each display cell (100) are oriented toward the viewer as a display surface of the device (400). The optical states of the individual display cells (100) are selectively altered by a passively addressed control system such that light cells (401) and dark cells (402) are present in the display device (400) to display desired patterns or images to a viewer.

Typically, between each image being displayed, all the pixels of the electrophoretic display device are reset to a common optical state. Then, pixels that are to change optical state are addressed, and pixels that are not to change from that common optical state of the reset are not addressed. For explanatory purposes in the present example, individual cells (402) are described as “addressed” if the cells (402) are in an optical state that gives the visible portion of the cells (402) a dark color. As pointed out previously, this dark color may come from colored electrophoretic particles or from a colorant in the liquid crystal host fluid (109, FIG. 1) of the cells (402). Likewise, cells (401) are referred to as “not addressed” or “unaddressed” when they remain in a reset optical state that gives the visible portion of the cells (401) a white or light color. This light color may also come from colored electrophoretic particles or from a clear or colored liquid crystal host fluid (109, FIG. 1).

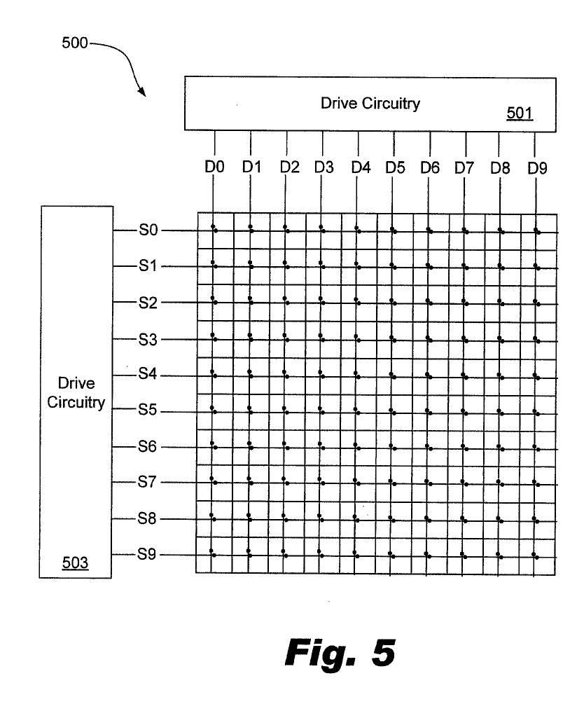

Referring now to FIG. 5 an illustrative passive control system (500) is shown for the electrophoretic display device (400, FIG. 4) described previously. The illustrative control system (500) includes 10 row select lines (S0-S9) and 10 column select lines (D0-D9). Each of the row select lines (S0-S9) corresponds to an individual row in the matrix of the display device (400, FIG. 4) and is connected to the first electrode (103, FIG. 1) of each of the cells (401, 402) in the corresponding row. Thus, by imparting a voltage on a row select line, each of the display cells (401, 402) in the selected row of the matrix would receive that voltage at the first electrode (103, FIG. 1). Drive circuitry (501, 503) is connected to each of the row select lines (S0-S9) and column select lines (D0-D9) to impart the required voltages to the select lines.

Likewise, each of the column select lines (D0-D9) corresponds to an individual column in the matrix of the display device (400, FIG. 4), and is connected to the second electrode (113, FIG. 1) of each of the cells (401, 402, FIG. 4) in the corresponding column. Thus, by imparting a voltage on a column select line, each of the display cells (401, 402, FIG. 4) in the selected column of the matrix would receive that voltage at the second electrode (113, FIG. 1).

As described above, in conventional passively addressed display devices, an image is written to the device in a single pass. During this single pass, addressed cells experience a high voltage one time, while unaddressed cells experience a fraction of that voltage (typically between a half and a third of the high voltage) many times. Some electrophoretic devices exhibit crosstalk between display cells when addressed in this fashion. It is observed that this is partially due to the level of voltage used to write to the cells during the single pass. However, in most cases, lowering the write voltages used in a single pass, passively addressed device results in a failure to produces a sufficient optical contrast between addressed cells and unaddressed cells.

The display devices (400, FIG. 4) of the present specification, however, are configured to undergo multiple lower voltage write passes, which essentially builds up the image over several passes. The write passes use voltages that are greater than the threshold voltage needed to align the molecules of the liquid crystal host fluid (109, FIG. 1) and move the charged particles (107, FIG. 1) to write the desired image to the display cells (402, 401, FIG. 4). Row select and column select voltages are chosen to maximize the difference in voltage between selected and non-selected display cells (402, 401, FIG. 4). During a write process, certain voltages are used on the row select lines (S0-S9) and the column lines (D0-D9) to write the desired image to the display cells (402, 401, FIG. 4). It may be noted that there are two thresholds in the display cell; (1) a threshold voltage sufficient to align the liquid crystal molecules (typically around 5V for the type of systems being described). This threshold is not necessarily sufficient to move the particles; and (2) a second threshold that is required to move the charged particles at a given pulse width. This second threshold may be referred to herein as the “system threshold.”

In the present example, a darker appearance is written to a display cell (401, 402) by allowing the collective migration of white electrophoretic particles (107, FIG. 1) towards the second electrode (113, FIG. 1) and away from the display surface. As the electrophoretic particles (107, FIG. 1) are negatively charged, two conditions must be met to allow the electrophoretic migration of the particles (107, FIG. 1) toward the second electrode (113, FIG. 1): (1) the net voltage (V2−V1, FIG. 1) must be greater than the threshold voltage that results in particle movement in the aligned liquid crystal molecules (109), and (2) the voltage (V2, FIG. 1) at the second electrode (113, FIG. 1) must be greater than the voltage (V1, FIG. 1) at the first electrode (103, FIG. 1)

The desired image is written to the display device (400, FIG. 4) systematically, one row at a time. Each row sequentially receives a “row select” voltage on its corresponding row select line when selected for data writing. Data may only be written to a row in the display device (400, FIG. 4) when the correct row select voltage is present on the corresponding select line. Additionally, display cells (401, 402, FIG. 4) within the selected row that are to be addressed receive a “column select” voltage on corresponding data lines.

Thus, for a display cell (401, 402, FIG. 4) in the display device (400, FIG. 4) to be addressed, the cell (401, 402, FIG. 4) must receive the correct row select voltage in the row corresponding to the cell (401, 402, FIG. 4) and the correct column select voltage on the data line corresponding to the cell (401, 402, FIG. 4). With the correct row select voltage on the first electrode (103, FIG. 1) and the correct column select voltage on the second electrode (113, FIG. 1) of the display cell (401, 402, FIG. 4), a net difference between the column select voltage and the row select voltage is greater than the threshold voltage needed to align the molecules of the liquid crystal host fluid (109, FIG. 1) and move the charged particles (107, FIG. 1). This enables the electrophoretic movement of the electrophoretic particles (107, FIG. 1).

By maintaining a lower writing voltage, cross-talk between adjacent display cells (401, 402, FIG. 4) is dramatically reduced, while contrast between light and dark cells (401, 402, FIG. 4) may be increased using the multiple pass system of the present specification.

The row select and column select voltages are chosen such that display cells (401, 402, FIG. 4) that experience the column select voltage on the column line, but an inadequate row select voltage in the corresponding row line, do not receive a net difference between the column select voltage and the row select voltage that is greater than the threshold needed to align the molecules of the liquid crystal host fluid (109) or to move the charged particles (107, FIG. 1). Thus, the electrophoretic particles (107, FIG. 1) in the display cells (401, 402, FIG. 4) do not move. Likewise, display cells (401, 402, FIG. 4) that experience the correct row select voltage in the corresponding row line, but not the correct column select voltage on the corresponding data line do not receive a net difference between the column select and row select voltages that is greater than the threshold need to move the charged particles (107, FIG. 1).

The degree to which a visual change occurs in a display cell (401, FIG. 4) addressed after a pass in this process depends on two factors: how much greater the voltage is at the second electrode (113, FIG. 1) than at the first electrode (103, FIG. 1) and the duration of time that this net voltage difference is present. As explained previously, the display devices (400, FIG. 4) of the present specification use multiple, lower voltage passes to write a desired image to the devices (400, FIG. 4). By using a net writing voltage that is within a few volts of the threshold needed to move the charged particles (107, FIG. 1) in the molecules of the liquid crystal host fluid (109, FIG. 1), each successive write pass in a transitioning display cell brings the electrophoretic particles (107, FIG. 1) closer to their desired position within the display cell (401, 402, FIG. 4) without completing writing the display cells (401, 402, FIG. 4) in any one pass.

This multi-pass writing process may greatly enhance the visual contrast between addressed display cells (402, FIG. 4) and unaddressed display cells (401, FIG. 4). Additionally, a smaller net voltage difference between the addressed display cells (402, FIG. 4) and the unaddressed display cells (401, FIG. 4) during the writing process greatly reduces optical cross-talk between display pixels (401, 402, FIG. 4) that are addressed multiple times.

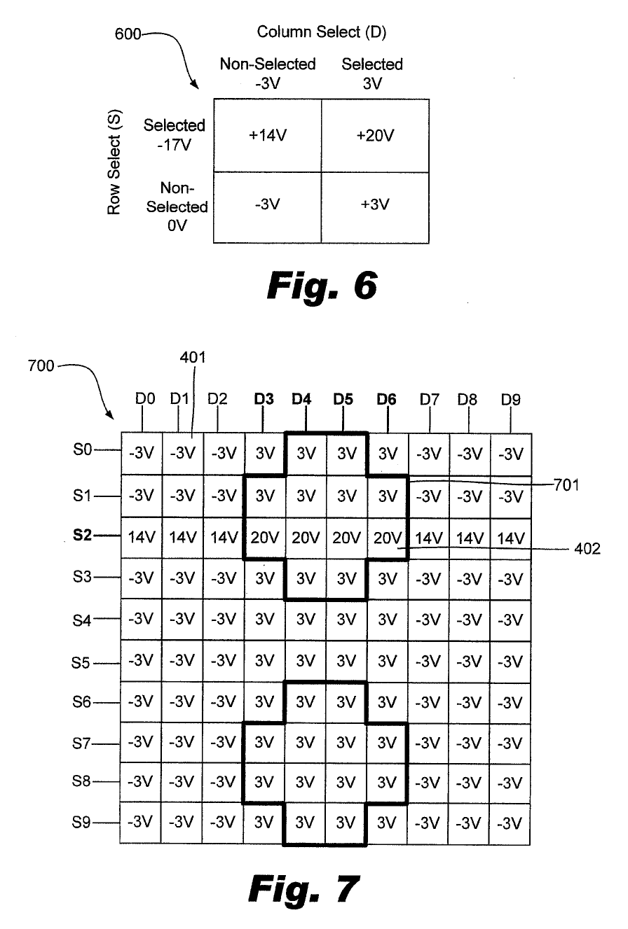

Referring now to FIG. 6, a table (600) is shown of illustrative control voltages and the net voltage effect on display cells of different combinations of these control voltages. The illustrative control voltages of the present example are chosen for a matrix of illustrative electrophoretic display cells having a voltage threshold of around 17V±2V.

In the present example, a selected row receives a row select voltage of −17V on the corresponding select line. The row select line is in communication with each of the first electrodes (103, FIG. 1) of display cells (401, 402, FIG. 4) in the display device (400, FIG. 4). A non-selected row receives a row select voltage of 0V on the corresponding select line.

Similarly, a selected column receives a column select voltage of 3V on the corresponding column select line. The column select line is in electrical communication with each of the second electrodes (113, FIG. 1) of the display cells (401, 402, FIG. 4) of the display device (400, FIG. 4). A non-selected column receives a column select voltage of −3V.

Therefore, measuring the voltage difference from the second electrode (113, FIG. 1) to the first electrode (103, FIG. 1), display cells (401, 402) in a selected row experience a net voltage of +14V when corresponding columns are not selected, and +20V when corresponding columns are selected. The +20V net voltage is greater than the system threshold, which enables movement of electrophoretic particles (107, FIG. 1) towards the second electrode (113, FIG. 1) and thereby alters the optical appearance of the display cells (401, 402). The degree to which the optical appearance of the display cells is altered (401, 402) depends on the length of time in which the net voltage difference is experienced. The display cells (401, 402) experiencing a net voltage of +14V from the second electrodes (113, FIG. 1) to the first electrode (103, FIG. 1) do not experience a high enough net voltage difference to overcome the system threshold, and no electrophoretic movement occurs.

Moreover, display cells (401, 402, FIG. 4) in a non-selected row receive a net voltage difference from the second electrode (113, FIG. 1) to the first electrode (103, FIG. 1) of −3V when corresponding columns are not selected and +3V when corresponding columns are selected. Neither case produces a net voltage between the electrodes (113, 103, FIG. 1) of the display cells (401, 402) that overcomes the system threshold, and no electrophoretic movement or change in optical appearance occurs.

Referring now to FIG. 7, the illustrative passive control system (500) of FIG. 5 is shown during a stage of a multi-pass writing process. The multi-pass writing process is producing a pattern (701) of addressed display cells similar to that shown in FIG. 3. Illustrative net voltages are shown on each of the display cells (401, 402). The passive control system (500) is shown writing the third row of display device (400, FIG. 4). For this reason, the row select line (S2) corresponding to the third row is selected.

To produce the desired pattern (701), the display cells corresponding to the fourth, fifth, sixth, and seventh columns must be addressed. Therefore column select lines (D3, D4, D5, D6) for these columns are selected, and the display cells experience a net voltage of 20V from the second electrode (113, FIG. 1) to the first electrode (103, FIG. 1). The column select lines (D0, D1, D2, D7, D8, D9) for the remaining columns in the selected row are not selected, and their corresponding display cells receive a net voltage of 14V between the electrodes (113, 103, FIG. 1). In all other rows, display cells in the second, third, fourth, and fifth columns receive a net voltage difference of +3V, and all other cells receive a net voltage difference of −3V, measured from the second electrode (113, FIG. 1) to the first electrode (103, FIG. 1).

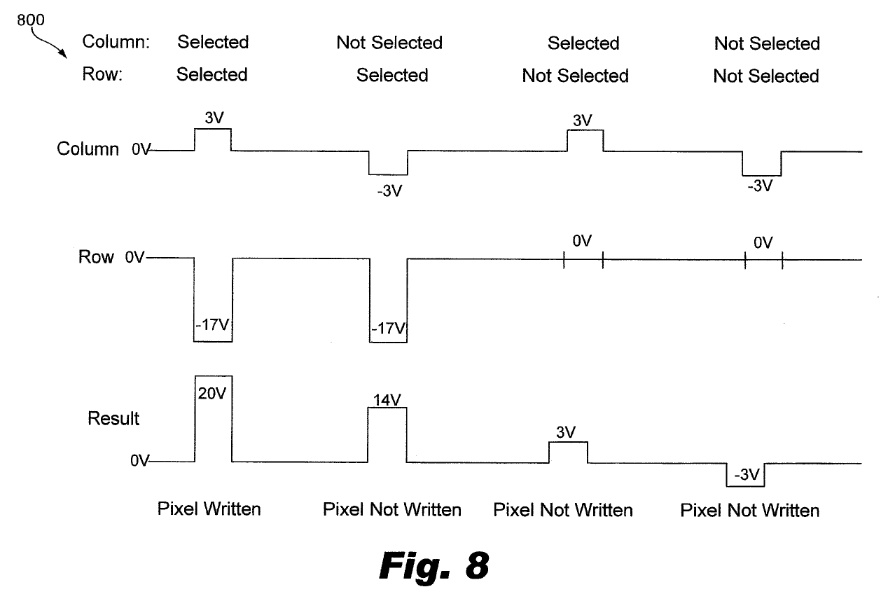

FIG. 8 shows a diagram (800) depicting these illustrative control voltages during different operations of the illustrative display device (400, FIG. 4) according to principles described herein. When a display cell (401, 402) becomes dark using the voltage signals depicted, a pixel in the display device (400, FIG. 4) is addressed.

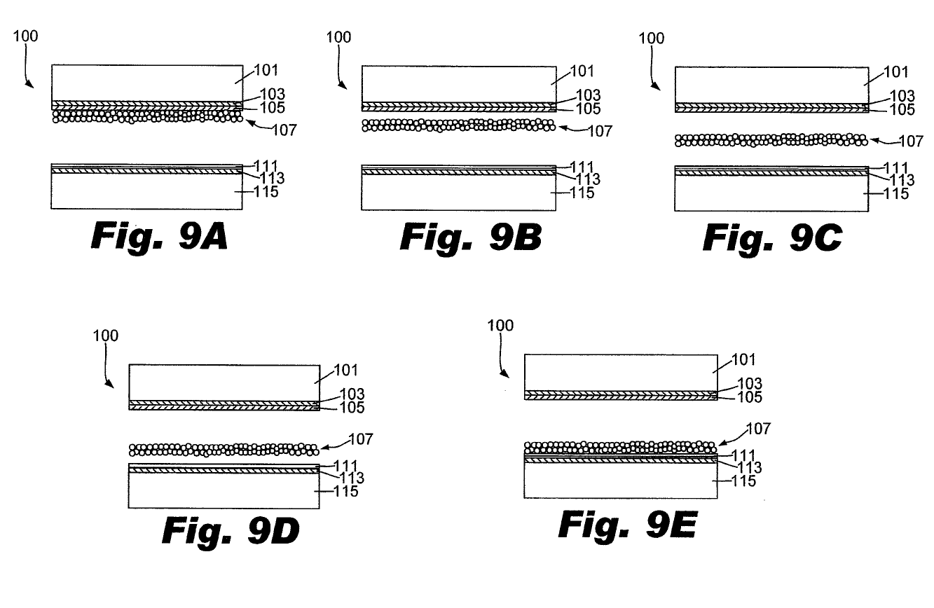

Referring now to FIG. 9, an illustrative electrophoretic display cell (100) is shown during various points of a multi-pass write process. FIG. 9A shows the display cell (100) in a light state after a reset. In the light state, white, negatively charged electrophoretic particles (107) are positioned close to the first electrode (103). FIG. 9B shows a slight migration of the electrophoretic particles (107) towards the second electrode (113) after a first write pass. FIG. 9C shows another slight migration of the electrophoretic particles (107) towards the second electrode (113) after another write pass. FIGS. 9D and 9E show the continued electrophoretic migration of the particles (107) toward the second electrode (113) after third and fourth write pass cycles. In embodiments having a darkly colored liquid crystal host fluid (109), the display cell takes on an increasingly darker appearance as the electrophoretic particles (107) migrate away from the first electrode (103).

In some embodiments, it may be desirable that the display cell (100) take on a transitional appearance or color obtainable by suspending the electrophoretic particles (107) in the liquid crystal host fluid (109) somewhere in between the first and second electrodes (103, 113). In these embodiments, the display cell (100) may experience a final state similar to the intermediary states shown in FIGS. 9B-9D. Using the present example, such transitional appearances or colors may include various shades of gray that can be created in the display cell when the white electrophoretic particles (107) are partially obscured by the darkly colored liquid crystal host fluid (109). The multi-pass writing process of such cells (100) may be configured to allow such transitional states and appearances due to the multistability of the liquid crystal host fluid (109).

### Illustrative Method

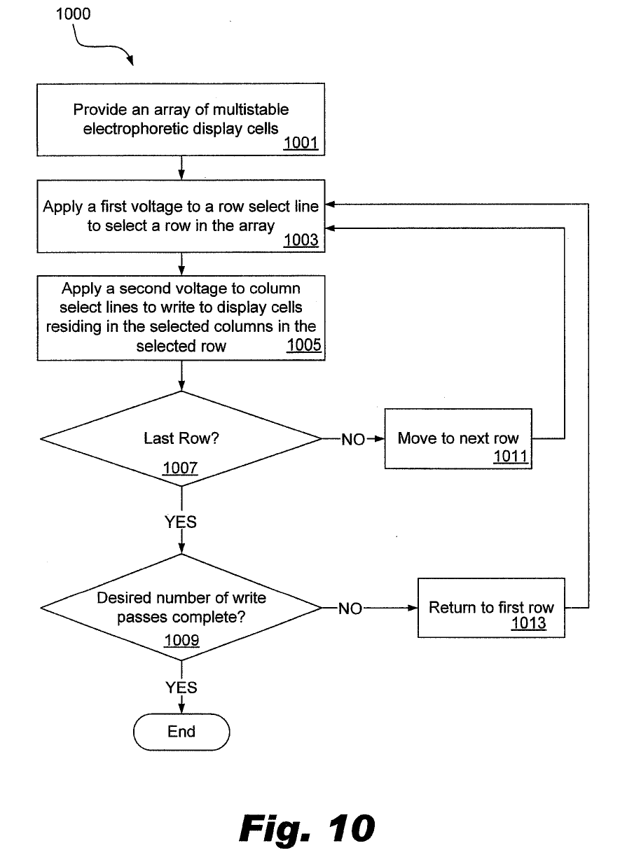

Referring now to FIG. 10, a flowchart of an illustrative method (1000) of electrophoretic display is shown. The method (1000) includes providing (step 1001) an array of multistable electrophoretic display cells. The array may be rectangular, having rows and columns. Each row may have a row select line, and each column may have a column select line, as previously explained. The electrophoretic display cells have voltage thresholds.

A first voltage is then applied (step 1003) to a row select line to select a row in the array. A second voltage is applied (step 1005) to display cells residing in the selected columns in the selected row. If additional rows remain in the array to be selected (determination 1007), the process moves (step 1011) to the next row and repeats the steps of applying voltages to the column and row select lines (steps 1003, 1005).

If no additional rows remain in the array to be selected (determination 1007), it is determined (decision 1009) if the desired number of write passes has been completed. A write pass in this context occurs when each row has been consecutively selected in the array. If it is determined (decision 1009) that the desired number of write passes has not been completed, then the process returns (step 1013) to the first row and begins again. If it is determined (decision 1009) that the desired number of write passes has been completed, the process is complete.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. An electrophoretic display apparatus comprising an array of cells, said apparatus comprising:
said array of cells each comprising first and second electrodes and a plurality of electrophoretic particles disposed between said electrodes, wherein said particles are dispersed in a host fluid and are multistable in positions between said electrodes; and
drive circuitry in electrical communication with each of said electrodes,
wherein said drive electronics are configured to transition addressed cells of said array from a first optical state to a second optical state with a plurality of successive write signals.

2. The electrophoretic display apparatus of claim 1, wherein said cell is contained by opposing substrates with at least one said substrate being optically translucent and corresponding to a display surface of said display apparatus.

3. The electrophoretic display apparatus of claim 1, wherein said host fluid is a liquid crystal host fluid that permits movement of said particles in response to voltage above a threshold.

4. The electrophoretic display apparatus of claim 3, wherein said drive electronics are configured to provide a net voltage between said electrodes that is greater than said threshold.

5. The electrophoretic display apparatus of claim 1, wherein said display apparatus is an Electrophoretically Controlled Nematic (EPCN) type display apparatus

6. The electrophoretic display apparatus of claim 5, wherein said array of cells is contained between opposing substrates, each substrate including a liquid crystal alignment layer.

7. The electrophoretic display apparatus of claim 6, wherein one of said alignment layers is a homeotropic alignment layer and the other of said alignment layers is a planar alignment layer.

8. The electrophoretic display apparatus of claim 1, wherein said display apparatus is an Electrophoretic Liquid Crystal (EPLC) type display apparatus

9. The electrophoretic display apparatus of claim 8, wherein said electrodes are disposed on a common substrate.

10. The electrophoretic display apparatus of claim 8, wherein said optical states are determined by a degree to which said particles are visible to a viewer of said display apparatus.

11. An electrophoretic display device, comprising:
an array of multistable electrophoretic display cells, wherein each of said display cells comprises a voltage threshold;
a passively addressed control system in electrical communication with said array of display cells; and
drive circuitry in electrical communication with said control system; wherein said drive circuitry is configured to write an image to said display cells through a plurality of successive write signals.

12. The electrophoretic display device of claim 11, said passively addressed control system comprising a plurality of row select lines and a plurality of column select lines; wherein a said display cell is addressed by applying a predetermined voltage differential between one of said row select lines and one of said column select lines.

13. The electrophoretic display device of claim 12, wherein each of said plurality of write signals comprises consecutively selecting each of said rows in said array, wherein display cells in each of said rows are selectively addressed upon selection of said rows by said drive circuitry.

14. The electrophoretic display device of claim 11, wherein said drive circuitry is configured to alter the optical appearance of said array by providing a net voltage differential to selected display cells that is greater than said voltage threshold.

15. A method of electrophoretic display, said method comprising:
providing an array of multistable electrophoretic display cells, wherein each of said display cells comprises a voltage threshold; and
writing an image to said display cells through a plurality of successive drive passes during which a write signal is selectively applied to addressed display cells.

16. The method of claim 15, wherein said image is written by selectively applying a net voltage differential to display cells in said array that is greater than said voltage threshold.

17. The method of claim 16, further comprising aligning liquid crystal molecules in said display cells with an electric field caused by said net voltage differential.

18. The method of claim 15, wherein each of said drive passes comprises: consecutively applying a first voltage to row select lines in said array and selectively applying a second voltage to column select lines as said first voltage is applied to said row select lines.

19. The method of claim 15, wherein said step of writing an image to said display cells is performed by drive circuitry in communication with said array.

20. The method of claim 15, wherein writing said image comprises moving charged particles into view in said addressed display cells.
